(19) United States
(12) Patent Application Publication
(10) Pub. No.: US 2009/0100616 A1
(43) Pub. Date: Apr. 23, 2009

(54) Decontamination Of Flakes

(75) Inventor: Arne Haase, Harrislee (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: KRONES AG, Neutraubling (DE)

(21) Appl. No.: 11/792,475

(22) PCT Filed: Dec. 8, 2005
(86) PCT No.: PCT/EP05/13165

§ 371 Date: May 30, 2008

(30) Foreign Application Priority Data
Dec. 10, 2004 (DE) 10 2004 059 808.8

(51) Int. Cl. B08B 9/00; B08B 5/00; B08B 6/00; B08B 3/10

(52) U.S. Cl. 15/3.5; 134/31; 134/1.1; 134/30

(57) ABSTRACT

A method and device for cleaning and decontaminating contaminated plastics, such as, for example, RPET or similar polymers, which have been crushed to flakes, where an ionized gas flows around the flakes.

### CROSS-REFERENCE TO RELATED APPLICATION

The present application is the United States National Phase of International Patent Application No. PCT/EP2005/013165 filed on Dec. 8, 2005, which application claims priority of Germany Patent Application No. 10 2004 059 808.8 filed Dec. 10, 2004. The entire text of the priority application is incorporated herein by reference in its entirety.

### FIELD OF THE DISCLOSURE

The disclosure relates to a method and a device for cleaning and decontaminating flakes.

### BACKGROUND

The use of plastics in the food industry is becoming increasingly widespread. To meet the rising demand for raw materials that are becoming scarce, used plastics have to be recycled. To be able to reuse plastics after their use in the food sector, a very intense cleaning or decontamination is required, because the appropriately stringent legal requirements for the purity of recycled plastics. Consequently, the levels of cleaning effectiveness have to be very high.

In the state of the art, different methods are already known to clean plastic flakes, particularly PET flakes, and prepare them for reuse.

Thus, for example, from JP 2002126664, a method is known in which the PET flakes are added in a vertical fluid-filled spiral screw conveyor to be cleaned of label residues or similar surface soiling.

Moreover, from JP 2002086446, a method is known, in which PET bottles are first cleaned, chopped into small pieces, and then subjected again to cleaning.

From JP 2003136531, a method is also known where ultrasound waves are used for cleaning PET flakes.

The problem of the described methods is the fact that, in each case, contaminants are removed only from the surface of the flakes. The contaminants which diffuse into the PET flakes are not removed by these methods. Thus, flakes which have been cleaned by these methods cannot be used in the food sector.

To remove contaminants from inside the flake material, the contaminants are expelled according to the state of the art by a heat treatment which can last up to several hours and is usually carried out at temperatures above 200° C.

The problem of these heating methods is, on the one hand, the length of the treatment time, and, on the other hand, the high temperature at which the treatment must occur, because both time and temperature mean high costs for the process.

### SUMMARY OF THE DISCLOSURE

Therefore, the problem of the present disclosure is to produce a method and a device for cleaning and decontaminating flakes, where contaminants located in the plastic material are also removed, and in where the process costs are reduced considerably.

If an ionized gas flows in this manner around the plastic flakes, then a cleaning effect occurs, which is completely surprising and cannot be explained in detail. The inter- and intramolecular processes in the interaction of the gaseous ions with the contaminants on or in the flakes are unknown.

The method according to the disclosure for the cleaning and decontamination of flakes is used particularly for crushed and contaminated plastic flakes, such as, for example, flakes from PET bottles, where it is also possible to use this method for the treatment of, for example, HDPE, PP, PEN, PVC, any polyolefins, PO, PA or RPET. The expression RPET (R for recycling) is used if PET material to be processed has already been used in another application.

Flakes denote all particles or objects that no longer present the size or shape of their original application form. Thus, flakes also denote plastic film residues, for example, whose thickness can be only a few micrometers, but whose surface can certainly cover several square centimeters or more. It is also possible for the flakes to consist, for example, of pressed or molded plastic bottles. Varying the flake dimensions does not influence the function of the method, instead it affects only the treatment time. It is preferred for the flakes to present a mean particle size of 4-7 mm, and a thickness of approximately 0.2-2 mm.

In an additional variant of the disclosure, plastic pellets and compactates can also be processed.

In carrying out the method, it does not matter whether the contaminants consist of surface soiling, such as, for example, label or adhesive residues, or whether the flakes are atomic/molecular, organic or inorganic compounds that enter by diffusion, microbes, fungi etc.

A special effect is achieved if the flow generated at the time of the introduction of the ionized gas is not too weak. If the flow is too strong, on the other hand, the flowing ionized medium cannot have its full effect.

The explanation for the high level of cleaning effectiveness is that the contaminants which enter into the flakes by diffusion do not become distributed homogeneously in a given flake with respect to its thickness. Most contaminants are located in the upper material layers.

During the treatment of flakes with ionized gas, several possibilities exist according to variants of the invention: in particular, the treatment can occur in a fluid or in a gaseous carrier medium. The carrier medium refers to the nonionized medium, in which the flakes are located during the cleaning process within a reactor unit. If the treatment occurs in a fluid medium, then this carrier medium is cleaned by exposure to the action of the ionized gas.

According to a variant of the disclosure, an acid or a base is used as liquid medium. As a result of the alteration of the flake surface caused by the acid or the base, the cleaning effect of the ionized gas is reinforced again. According to a preferred variant, water is used as fluid carrier medium.

According to a variant of the disclosure, the fluid carrier medium presents a temperature of 0-100° C., preferably 20-70° C., and, in a particularly preferred variant of the invention 30-60° C., because the increase in the temperature of the medium in comparison to room temperature further reinforces the cleaning effect.

The ion content of the carrier medium is a parameter by means of which the cleaning effectiveness of the method can be changed.

According to an additional variant of the disclosure, the treatment of the flakes takes place in a gaseous carrier medium. In a particularly preferred variant, the gaseous carrier medium is air, which greatly simplifies the construction of the installations, because no flake treatment systems that are separated from the environment have to be constructed. If the carrier medium is heated to warm or hot temperatures, then processing advantages can again be achieved due to the higher reaction rates. The temperature of the carrier medium moves in a range between −50° C. and +250° C., where a temperature between 50° C. and 150° C. is set preferably.

According to an additional variant of the disclosure, the possibility exists to flood the flakes located in the gaseous carrier medium with a fluid which has been enriched with ionized gas.

According to an additional variant of the disclosure, the treatment of the flakes occurs under an inert gas atmosphere, to prevent undesired reactions.

According to an additional variant of the disclosure, the treatment of the flakes occurs under vacuum conditions.

Preferably not only the carrier medium, but also the ionized gas, presents a temperature which is elevated compared to room temperature. It is also possible to heat the gas before its ionization. The temperature of the gas is between −50° C. to +250° C., where a temperature between 50° C. and 150° C. is preferred.

In a preferred variant of the disclosure, the ionized gas which flows around the flakes is air, irrespective of the carrier medium used. The advantage of air is that the process can be carried out very inexpensively with a high degree of effectiveness. The advantage of using other gases is that certain desired reactions between the contaminants and the ionized gas can occur, which facilitate the process course and thus increase the process rate. Here too, heating the treatment gas to be ionized entails advantages with respect to the process management and the achieved process times.

According to an additional variant, the flakes are subjected, prior to the treatment with ionized air, to an independent purification process, which may include the treatment with an acid or a base. This variant combines the advantages of the acid/base treatment of the flakes with the simple structure of the ionization unit. However, the independent purification process can also include a prior treatment with alcohols/alcohol solutions, a prior treatment in a dry environment and/or a prior treatment with surfactants.

The treatment time of the flakes is in a time window between 10 seconds and 20 minutes. In a particularly preferred variant, the treatment time is between one and five minutes, because the cleaning effectiveness no longer increases noticeably with increasing treatment time. The test series have shown in fact that after approximately 30 seconds, a cleaning effectiveness of much more than 90% is already achieved for certain soiling types. However, these values depend strongly on the thickness of the flake to be cleaned. If thicker flakes are cleaned (for example, difference in thickness between flakes from the body area of a PET bottle and the mouth area of a PET bottle), then longer cleaning times have to be used. However, with such thicker flakes, the cleaning effectiveness no longer increases significantly after a treatment time of approximately five minutes, in comparison to the time spent.

An advantage of this method is that both contaminants located in the surface of the flakes and contaminants adhering to the surface of the flakes are removed. Such contaminants can be, for example, adhesive residues, label residues, or other organic or inorganic extraneous soiling types.

If cleaning steps are carried out under dry conditions in particular, in the case of plastics to be recycled in gaseous media, then the problem often arises that the plastics become electrostatically charged as a result of mutual friction and other effects. This method now presents the advantage that the ionized gas also removes the electrostatic charge from the flakes.

It is possible to carry out the method continuously, discontinuously, or in the batch mode.

A device for the decontamination of plastic flakes presents at least an ionizer, an ionization tube, a reactor unit, where the ionizer can be installed in the reactor unit or outside of it. This reactor unit can be designed as a unit which can be closed off from the environment or as an open unit. As a rule, the unit can be closed off from the environment if the reaction is to be run in a vacuum or under conditions with a protective gas.

According to a preferred variant of the disclosure, the reactor unit is designed as a fluid container, which is preferably suitable for receiving water.

However, the reactor unit can also be a container that is suitable for being filled with a gas, and can receive gas under low, normal or excess pressure conditions.

The ionization tube is characterized in that it conveys the ionized gas from the ionizer into the reactor unit. If the ionizer is in the reactor unit, no ionization tube may be needed to bring the gas in contact with the flakes. It is preferred for the ionization tube to present, in the interior of the reactor unit, holes that are distributed over its circumference, through which the gas can be distributed towards the flakes. It is also conceivable to make the ionization tube from sintered material and/or to provide it with membranes, to distribute the gas. Any other type of distributor can also be used.

According to a variant of the disclosure, a blower is located in front of or behind the ionizer, to set the gas or the ionized gas into a flowing movement, to introduce it into the reactor unit.

According to an additional variant, a heating module is located in the area of the gas transport to the reactor unit, which warms or heats the gas to be ionized or the ionized gas, before it is guided into the reactor unit.

### BRIEF DESCRIPTION OF THE DRAWINGS

The method is explained in greater detail with reference to the following drawings. In the drawings:

FIG. 1 shows a device for carrying out the method,

FIG. 2 shows another device for carrying out the method,

FIG. 3 shows a schematic representation of a cleaning step,

FIG. 4 shows a graphic representation of the cleaning effectiveness over the treatment time when carrying out the method with thin “wall flakes,” and

FIG. 5 shows a graphic representation of the cleaning effectiveness over the treatment time when carrying out the method with thick “neck flakes.”

### DETAILED DESCRIPTION

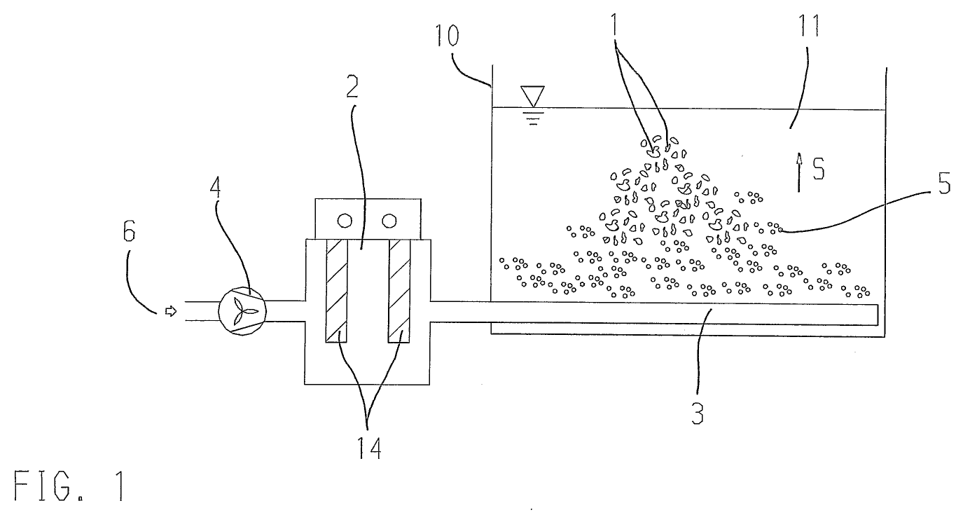

FIG. 1 shows an embodiment of a device for carrying out the method. In this device, air is used as gaseous medium to be ionized. The air is led in the direction of a gas inlet 6 through a blower 4 into an ionizer 2. In the ionizer 2, the air molecules pass by two electrodes 14 and are ionized. After the ionization, the air molecules are led along an ionization tube 3 in the direction of a reactor unit 10. The ionization tube 3, inside the reactor unit 10, presents small holes-not shown here-through which the ionized air molecule 5 can enter into the reactor unit 10. In the reactor unit 10, water 11 is located as a carrier medium for the flakes 1 to be treated. Into this water 11, which presents a temperature of approximately 2030° C., the flakes 1 to be cleaned are introduced. The ionized air molecules 5, which exit through the holes of the ionization tube 3, flow around the flakes 1 from the bottom of the reactor unit 10 against gravity, in the direction of the water surface, in such a way that the contaminants are removed from the flakes 1 and transported away in the direction of a flow S.

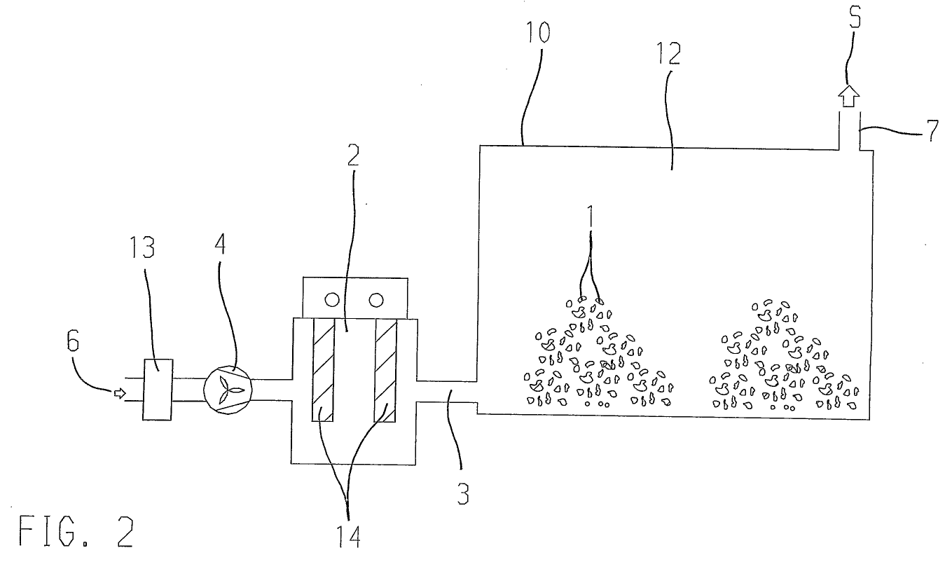

FIG. 2 shows an additional embodiment of a device for carrying out the method. In this example as well, air is used as gas to be ionized. The air is led in the direction of the gas inlet 6 through a heating module 13, to increase the temperature in comparison to room temperature, for the continued course of the process. After the warming phase, the air is led through the blower 4 into the ionizer 2. From there, it is ionized again at two electrodes 14, and led through the ionization tube 3 into the reactor unit 10.

The reactor unit 10 consists of a closed reaction chamber with an inlet and an outlet, where the inlet is formed by the ionization tube 3 and the outlet by an exhaust air pipe 7. Inside the reactor unit 10, in contrast to the embodiment example according to FIG. 1, a gaseous medium 12 is located, in which a treatment of the flakes occurs. The gaseous medium 12 here is air at a temperature of approximately 100° C.

The ionized air, which has been introduced through the ionization tube 3, flows around the flakes 1 in such a way that the contaminants are expelled from the flakes 1 and removed in the direction of the flow direction S that becomes established, through the exhaust air pipe 7. The air stream that is introduced through the ionization tube 3 into the reactor unit 10 is so strong here that the flakes 1 are stirred up in a vortex, and are continuously mixed again. In this manner, an optimal cleaning of all the flakes 1 is achieved.

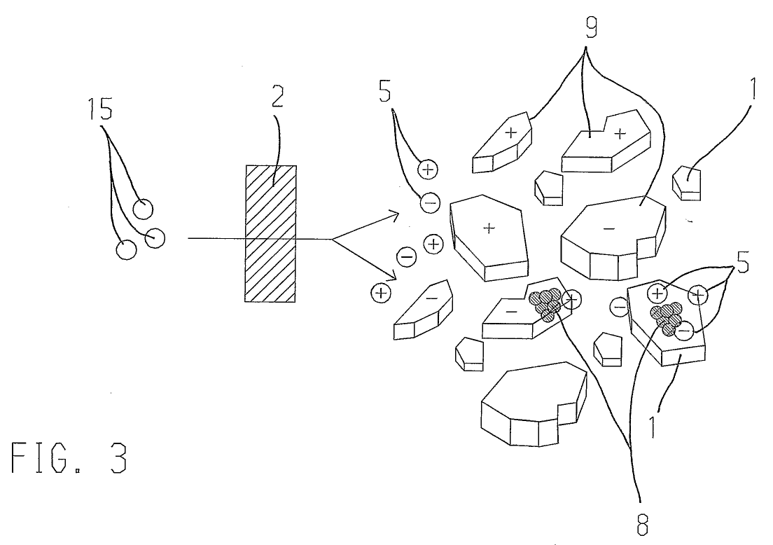

FIG. 3 shows schematically a part of the cleaning or decontamination procedure, as it can be carried out by the method according to claim 1. Nonionized gas molecules 15 are ionized by passing the ionizer 2, and are now available for the cleaning or decontamination of the flakes 1.

As the ionized air molecules 5 flow past the flakes 1 which present contaminants 8, said molecules remove the contaminants 8 and transport them away.

If, in the meantime, for reasons pertaining to the given circumstances, statically charged flakes 9 occur, or if statically charged soiling particles are located on the flakes 1 because of certain circumstances, then the flow of the ionized air molecules 5 around the flakes 1 or around the statically charged flakes 9 results in a neutralization of the static charge. After a treatment time T which is a function of the thickness of the flakes 1, the contaminants, or the static charges of the flakes 1, or the soiling particles fixed to their surface have been removed, and the flakes are available for further treatment or processing steps.

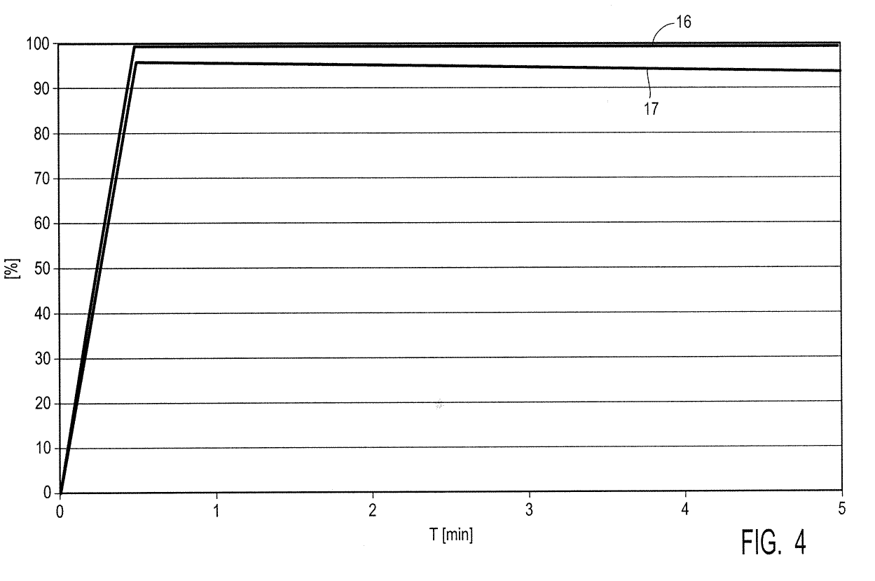

The curves in FIG. 4 represent the variations of the cleaning effectiveness as a percentage over the treatment time T of flakes according to the method. In carrying out a test, thin wall flakes were treated in a device according to FIG. 1. “Thin” here refers to flakes whose thickness is smaller than or equal to 0.5 mm. Previously, the flakes had been provided under defined conditions with the contaminants toluene and benzophenone. The two curves show the cleaning effectiveness over the treatment time T of toluene-soiled particles 16 and benzophenone-soiled particles 17. Here, the exceedingly surprisingly effect that occurred was that, after a treatment time of 30 seconds, 99.5 percent of the toluene and 96.0 percent of the benzophenone had already been removed. Another very surprising result is that, in the case of these thin-walled flakes, an increase in the treatment time no longer produces a higher removal of the contaminants 8. Thus, the cleaning effectiveness with respect to toluene remains at the measured value of 99.6 percent for toluene, and approximately 96 percent for benzophenone, after one, two and five minutes.

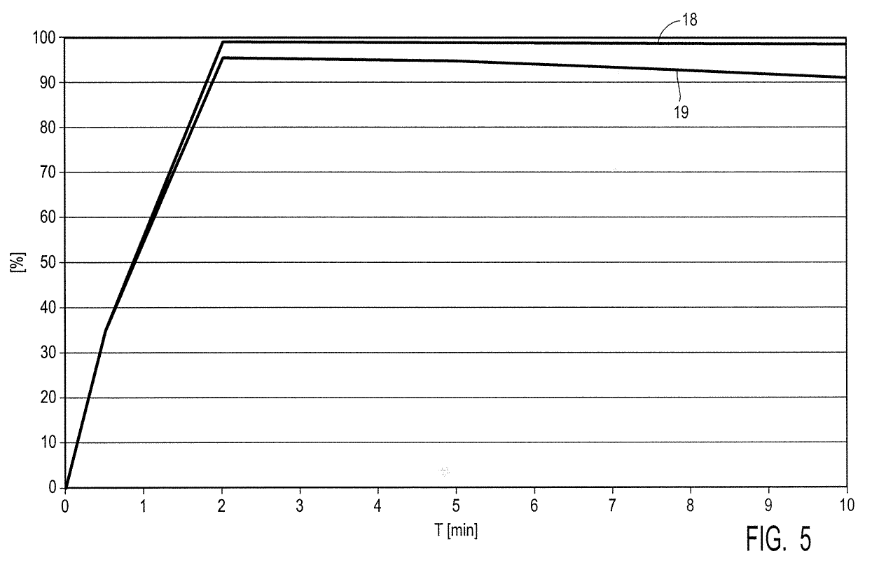

In a device according to FIG. 1, thick flakes (approximately 1-2.5 mm) are also treated by the present method. In FIG. 5, the levels of cleaning effectiveness are plotted for the contaminants toluene 18 and benzophenone 19 against the treatment time T. With these thicker flakes as well, the very surprising effect was confirmed, since a cleaning effectiveness of more than 95 percent can be achieved after a relatively brief treatment time T. However, the treatment time increases as a result of the greater thickness. After 30 seconds, one gets a cleaning effectiveness of 35.4 percent for toluene and of 36.8 percent for benzophenone. After treatment time T of two minutes, the treated flakes contain only 0.8 percent toluene and 4.1 percent benzophenone with respect to the initial concentration. Here too, it is again apparent that the levels of cleaning effectiveness very rapidly reach their maximum value, which is more than 95 percent in each case.

1. Method for cleaning and decontaminating contaminated plastics, particularly PET, that have been crushed to flakes (1), comprising flowing an ionized gas around the flakes (1).

2. Method according to claim 1, wherein the plastic flakes (1) are PET flakes.

3. Method according to claim 1, wherein contaminants (8), which have diffused into the flakes (1), are removed by the step of decontamination.

4. Method according to claim 1, wherein the flakes (1) are in a fluid medium (11) during the treatment with ionized gas.

5. Method according to claim 1, wherein the flakes (1) are in a gaseous medium (12) during the treatment with ionized gas.

6. Method according to claim 4, wherein the fluid medium (11) is water.

7. Method according to claim 4, wherein the fluid medium (11) is an acidic medium.

8. Method according to claim 4, wherein the fluid medium (11) is an alkaline medium.

9. Method according to claim 4, wherein the temperature of the fluid medium (11) is in a range of 0-110° C.

10. Method according to claim 5, wherein the temperature of the gaseous medium is in a range of 0-150° C.

11. Method according to claim 1, wherein the ionized gas is air.

12. Method according to claim 1, wherein the ionized gas is a plasma.

13. Method according to claim 1, wherein the ionized gas, prior to being flowed around the flakes (1), is warmed.

14. Method according to claim 1, wherein the treatment time of the flakes (1) in the ionized gas stream is in the range of between 10 seconds and 20 minutes.

15. Method according to claim 1, wherein contaminants (8), which are located on the surface of the flakes (1), are removed by the decontamination step.

16. Method according to claim 13, wherein the ionized gas stream is used to eliminate the electrostatic charge of the flakes (1).

17. Method according to claim 1, wherein in a separate step prior to the decontamination of the flakes (1) with ionized gas, a purification process is carried out for cleaning the surface of the flakes (1) in one of a base, an acid, an alcohol solution, or a dry environment.

18. A device for cleaning and decontaminating flakes (1) of crushed contaminated plastics, particularly PET, comprising an ionizer (2), an ionization tube (3), a reactor unit (10), and an ionized gas which flows around the flakes located in the reactor unit.

19. Device according to claim 18, wherein the ionization tube (3) presents small holes in the area of the reactor unit (10), through which the ionized gas flows.

20. Device according to claim 18, and a blower (4) is installed one of before or after the ionizer (2).

21. Device according to claim 18, and a heating module (13) is installed one of before or after the ionizer (2).

22. Device according to claim 18, wherein the reactor unit (10) is filled with a fluid medium (11).

23. Device according to claim 18, wherein the reactor unit (10) is filled with a gaseous medium (12).

24. Device according to claim 18, and a vacuum is applied to the reactor unit (10).

25. Method according to claim 5, wherein the gaseous medium (12) is air.

26. Method according to claim 9, wherein the temperature range is of 20-70° C.

27. Method according to claim 9, wherein the temperature range is of 30-60° C.

28. Method according to claim 10, wherein the temperature range is of 20-80° C.

29. Method according to claim 13, wherein the ionized gas is warmed to a temperature in the range of 20-80° C.

30. Method according to claim 14, wherein the treatment time is in the range of between 1 minute and 5 minutes.

31. Method according to claim 22, wherein the fluid medium is water

32. Method according to claim 23, wherein the gaseous medium is air.
